(19) United States
(12) Patent Application Publication
(10) Pub. No.: US 2022/0005368 A1
(43) Pub. Date: Jan. 6, 2022

(54) UPSKILL MANAGEMENT

(71) Applicant: INTERNATIONAL BUSINESS MACHINES CORPORATION, Armonk, NY (US)

(72) Inventors: Craig M. Trim, Ventura, CA (US); Mary Rudden, Denver, CO (US); Jeremy R. Fox, Georgetown, TX (US); Nadiya Kochura, Bolton, MA (US); Fang Lu, Billerica, MA (US)

(21) Appl. No.: 16/917,965

(22) Filed: Jul. 1, 2020

(51) Int. Cl. G09B 5/12; G06N 20/00; G06F 3/01; G06F 16/9535

(52) U.S. Cl. CPC G09B 5/12; G06F 16/9535; G06F 3/011; G06N 20/00

(57) ABSTRACT

A method, a structure, and a computer system for upskill management is disclosed. The exemplary embodiments may include collecting data relating to a user experiencing content and extracting one or more features from the data. In addition, the exemplary embodiments may include applying a model to the one or more features and identifying a learning style of the user based on the applied model.

### BACKGROUND

The exemplary embodiments relate generally to upskill training, and more particularly to upskill management.

Upskilling presents clear benefits to an organization by encouraging employee engagement, education, and retention. Upskilling increases productivity in terms of increased employee skills as well as reduced turnover and downtime. In fact, recruitment and training costs to replace an employee may cost up to three-quarters of that employee's yearly salary.

### SUMMARY

The exemplary embodiments disclose a method, a structure, and a computer system for upskill management. The exemplary embodiments may include collecting data relating to a user experiencing content and extracting one or more features from the data. In addition, the exemplary embodiments may include applying a model to the one or more features and identifying a learning style of the user based on the applied model.

### BRIEF DESCRIPTION OF THE SEVERAL VIEWS OF THE DRAWINGS

The following detailed description, given by way of example and not intended to limit the exemplary embodiments solely thereto, will best be appreciated in conjunction with the accompanying drawings, in which:

FIG. 1 depicts an exemplary schematic diagram of an upskill managing system 100, in accordance with the exemplary embodiments.

FIG. 2 depicts an exemplary flowchart 200 illustrating the operations of an upskill manager 134 of the upskill managing system 100, in accordance with the exemplary embodiments.

FIG. 3 depicts an exemplary block diagram depicting the hardware components of the upskill managing system 100 of FIG. 1, in accordance with the exemplary embodiments.

FIG. 4 depicts a cloud computing environment, in accordance with the exemplary embodiments.

FIG. 5 depicts abstraction model layers, in accordance with the exemplary embodiments.

The drawings are not necessarily to scale. The drawings are merely schematic representations, not intended to portray specific parameters of the exemplary embodiments. The drawings are intended to depict only typical exemplary embodiments. In the drawings, like numbering represents like elements.

### DETAILED DESCRIPTION OF THE SEVERAL VIEWS OF THE DRAWINGS

Detailed embodiments of the claimed structures and methods are disclosed herein; however, it can be understood that the disclosed embodiments are merely illustrative of the claimed structures and methods that may be embodied in various forms. The exemplary embodiments are only illustrative and may, however, be embodied in many different forms and should not be construed as limited to the exemplary embodiments set forth herein. Rather, these exemplary embodiments are provided so that this disclosure will be thorough and complete, and will fully convey the scope to be covered by the exemplary embodiments to those skilled in the art. In the description, details of well-known features and techniques may be omitted to avoid unnecessarily obscuring the presented embodiments.

References in the specification to “one embodiment”, “an embodiment”, “an exemplary embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of the exemplary embodiments, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is focused on the distinctive features or elements according to the various exemplary embodiments.

Upskilling presents clear benefits to an organization by encouraging employee engagement, education, and retention. Upskilling increases productivity in terms of increased employee skills as well as reduced turnover and downtime. In fact, recruitment and training costs to replace an employee may cost up to three-quarters of that employee's yearly salary.

Upskilling involves learning, and individuals tend to have a preferred mix of learning styles that is most effective for that particular individual. While individuals can nonetheless develop and advance learning abilities in less preferred styles, it is important to identify the right learning style fit for each individual in order to maximize learning efficiency and potential. Thus, while information generally enters the brain through any combination of the senses of touch, sight, hearing, smell, and taste, most individuals learn most efficiently with a particular sense or senses.

There is thus a need for a system to autonomously identify a learning style conducive to an individual and promote relevant learning materials in said learning style. Accordingly, the present invention provides for a system that identifies a learning style most effective for an individual and provides personalized recommendations for upskilling. Improvements of the present invention over the current art include personalized determination of a user's learning style as well as providing upskill materials relevant to and in accordance with the personalized learning style of the user.

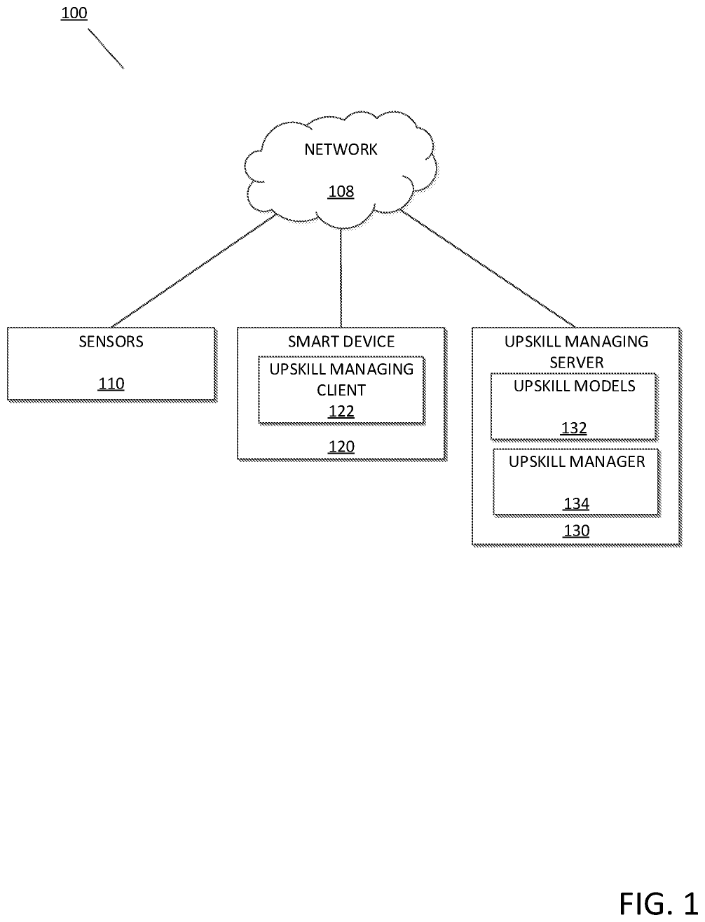

FIG. 1 depicts the upskill managing system 100, in accordance with exemplary embodiments. According to the exemplary embodiments, the upskill managing system 100 may include one or more sensors 110, a smart device 120, and an upskill managing server 130, which all may be interconnected via a network 108. While programming and data of the exemplary embodiments may be stored and accessed remotely across several servers via the network 108, programming and data of the exemplary embodiments may alternatively or additionally be stored locally on as few as one physical computing device or amongst other computing devices than those depicted. The operations of the upskill managing system 100 are described in greater detail herein.

In the exemplary embodiments, the network 108 may be a communication channel capable of transferring data between connected devices. In the exemplary embodiments, the network 108 may be the Internet, representing a worldwide collection of networks and gateways to support communications between devices connected to the Internet. Moreover, the network 108 may utilize various types of connections such as wired, wireless, fiber optic, etc., which may be implemented as an intranet network, a local area network (LAN), a wide area network (WAN), or a combination thereof. In further embodiments, the network 108 may be a Bluetooth network, a Wi-Fi network, or a combination thereof. The network 108 may operate in frequencies including 2.4 gHz and 5 gHz internet, near-field communication, Z-Wave, Zigbee, etc. In yet further embodiments, the network 108 may be a telecommunications network used to facilitate telephone calls between two or more parties comprising a landline network, a wireless network, a closed network, a satellite network, or a combination thereof. In general, the network 108 may represent any combination of connections and protocols that will support communications between connected devices.

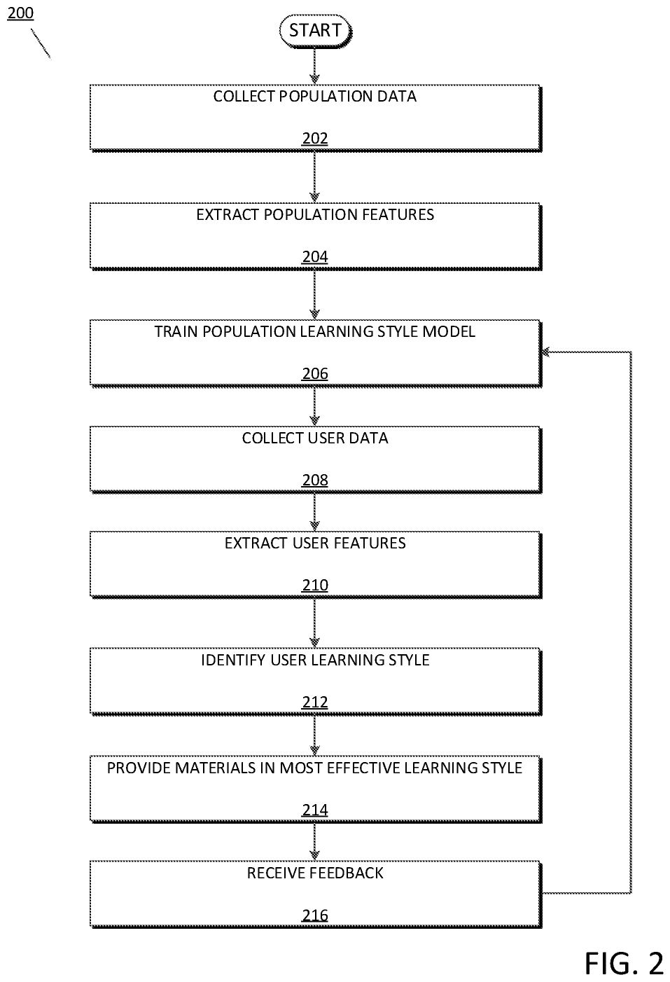

In exemplary embodiments, the sensors 110 may be one or more devices capable of collecting raw data streams related to determining a learning style of a user, and thus may collect raw data relating to both a user as well as the content experienced by the user. Accordingly, the raw data streams may include user audio, user video, user movement, user biometric data, etc., as well as content data such as type (e.g., text, audio, images, video, data streams, browsing history, social media history, messages, etc.) and interaction therewith (e.g., scrolling, selecting, highlighting, navigating, etc.). In embodiments, the sensors 110 may communicate with the network 108, as illustrated, or with the smart device 120 through means such as WiFi, Bluetooth, Near Field Communication (NFC), etc. In general, the sensors 110 may be any device capable of collecting data relating to an individual experiencing content. The sensors 110 are described in greater detail with respect to FIG. 2-5.

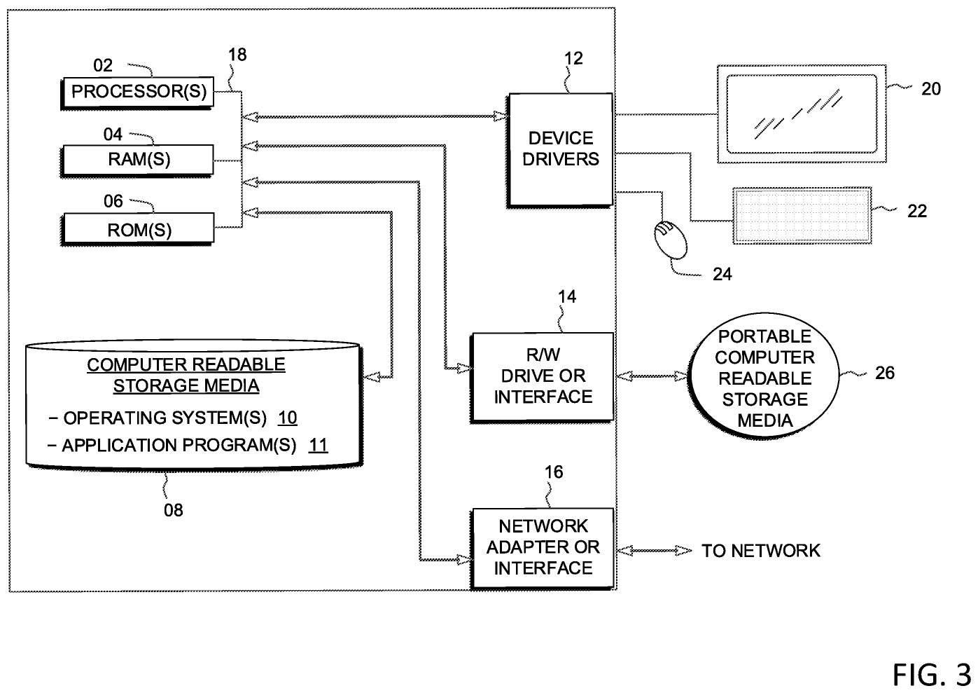

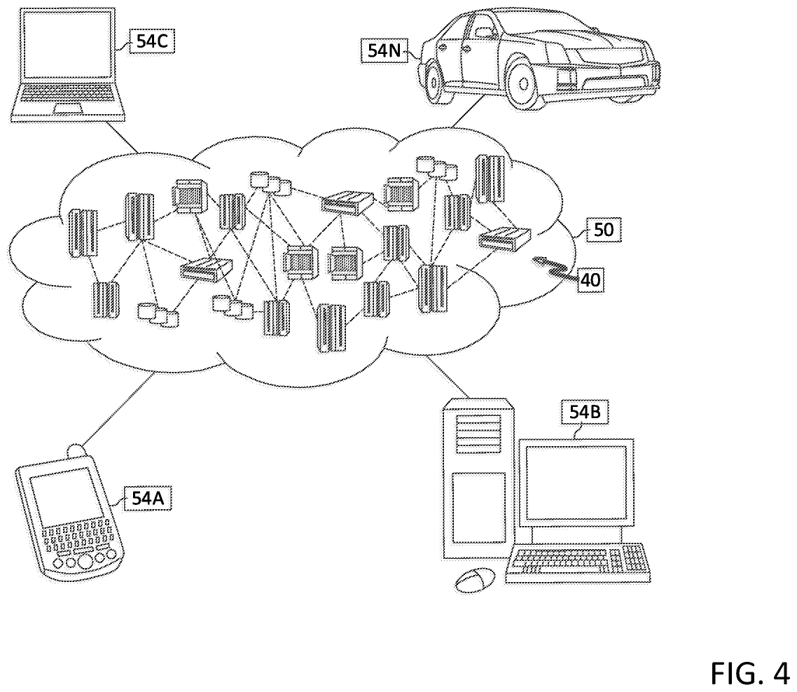

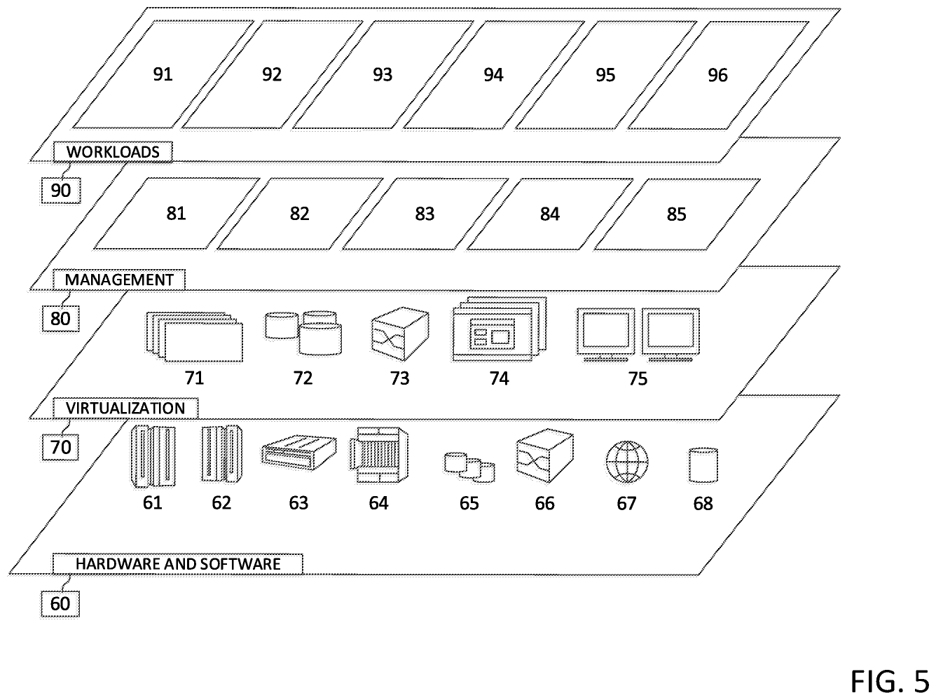

In exemplary embodiments, the smart device 120 includes an upskill managing client 122 and may be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, an IoT device, or any other electronic device or computing system capable of sending and receiving data to and from other computing devices. While the smart device 120 is shown as a single device, in other embodiments, the smart device 120 may be comprised of a cluster or plurality of computing devices, in a modular manner, etc., working together or working independently. The smart device 120 is described in greater detail as a hardware implementation with reference to FIG. 3, as part of a cloud implementation with reference to FIG. 4, and/or as utilizing functional abstraction layers for processing with reference to FIG. 5.

The upskill managing client 122 may act as a client in a client-server relationship, and may be a software and/or hardware application capable of receiving raw data collected by the sensors 110. In addition, the upskill managing client 122 may be further capable of communicating with and providing a user interface for a user to interact with a server and other computing devices via the network 108. Moreover, the upskill managing client 122 may be further capable of transferring data from the smart device 120 to and from other devices via the network 108. In embodiments, the upskill managing client 122 may utilize various wired and wireless connection protocols for data transmission and exchange, including Bluetooth, 2.4 gHz and 5 gHz internet, near-field communication, Z-Wave, Zigbee, etc. The upskill managing client 122 is described in greater detail with respect to FIG. 2-5.

In exemplary embodiments, the upskill managing server 130 includes one or more upskill models 132 and an upskill manager 134, and may act as a server in a client-server relationship with the upskill managing client 122. The upskill managing server 130 may be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, an IoT device, or any other electronic device or computing system capable of sending and receiving data to and from other computing devices.

While the upskill managing server 130 is shown as a single device, in other embodiments, the upskill managing server 130 may be comprised of a cluster or plurality of computing devices, in a modular manner, etc., working together or working independently. The upskill managing server 130 is described in greater detail as a hardware implementation with reference to FIG. 3, as part of a cloud implementation with reference to FIG. 4, and/or as utilizing functional abstraction layers for processing with reference to FIG. 5.

The upskill models 132 may be one or more algorithms modelling a correlation between one or more learning styles and one or more features. In particular, the upskill models 132 may correlate sensory learning styles such as visual, aural, kinetic, social, solitary, logical, etc., with features relating to both a user and content experienced by the user. In embodiments, the features may be extracted from raw data streams, such as user audio, user video, user movement, user biometric data, etc., as well as content data such as type (e.g., text, audio, images, video, data streams, browsing history, social media history, messages, etc.) and interaction therewith (e.g., scrolling, selecting, highlighting, navigating, etc.). The extracted features may relate to a user interactivity level, for example the use of visual tools such as notetaking, highlighting, mapping, charting, outlining, etc. The extracted features may also relate to outgoingness/quietness, for example participation in discussions, active listening, explaining, expression of opinions, providing comments/feedback, studying in groups vs. solo, and keen auditory memories (use of tones, rhythms, songs, jingles, etc.). In addition, the extracted features may also relate to a level of hands-on activity, for example use of physical objects, role-playing/dancing/performing, demonstrations, etc. In embodiments, the features may further relate to user personality, for example interests of the user, resources used in research, user preferences, user natural language, user sentiment, user concentration level, user circadian rhythms, etc. Lastly, the features may relate to the content experienced by the user, for example a type of the content (e.g., audio, video, image, text, outlines, charts, flowcharts, tree diagrams, quizzes, flashcards, etc.) and interactions therewith (e.g., scrolling, selecting, highlighting, navigating, etc.). In embodiments, the upskill manager 134 may train the upskill models 132 in a supervised manner based on the features extracted for users with known (i.e., labelled) learning styles, and may be done so using machine learning techniques such as neural networks. The upskill manager 134 may then input the extracted features of users with unknown learning styles into the upskill models 132 in order to determine a learning style of those users. The upskill models 132 are described in greater detail with respect to FIG. 2-5.

The upskill manager 134 may be a software and/or hardware program that may be capable of collecting population data and extracting population features in order to train the upskill models 132. In addition, the upskill manager 134 may be capable of collecting user data and extracting user features in order to identify a learning style of the user based on applying the upskill models 132. Based on the output of applying the upskill models 132 to the extracted user features, the upskill manager 134 may be capable of suggesting a most effective learning style to the user and receiving feedback based on the suggestion. The upskill manager 134 is described in greater detail with reference to FIG. 2-5.

FIG. 2 depicts an exemplary flowchart 200 illustrating the operations of the upskill manager 134 of the upskill managing system 100, in accordance with the exemplary embodiments.

The upskill manager 134 may collect population data (step 202). In exemplary embodiments, the upskill manager 134 may collect raw data of both the populations of users as well as the content experienced by the populations via the one or more sensors 110 and the upskill managing client 122. In particular, the upskill manager 134 may collect the population data by utilizing the sensors 110 to collect user data streams such as user audio, video, movement, biometric data, etc., as well as the upskill managing client 122 in order to collect content data streams such as content type (e.g., text, audio, images, video, movement, etc.) user interaction (e.g., scroll, click, select, review, navigate, etc.), data streams, browsing history, social media history, messages, etc. In embodiments, the upskill manager 134 may additionally prompt or otherwise receive from the population of users a preferred learning style of each user for training the upskill models 132. Moreover, in embodiments, the upskill manager 134 may further receive demographic, professional, and personal information from the population of users in order to further develop and refine the upskill models 132. In general, the upskill manager 134 may collect any data streams relevant to a user interacting with content.

In order to better illustrate the operations of the up skill manager 134, reference is now made to an illustrative example wherein the upskill manager 134 collects data from a population of several hundred volunteers. Here, the upskill manager 134 implements a camera to capture audio and video data streams of populations experiencing one or more types of content. Similarly, the upskill manager 134 captures movement data of the populations by implementing a gyroscope, accelerometer, pressure sensor, etc., and captures biometric data of the populations using smart devices such as a smart watches. Moreover, the upskill manager 134 collects data streams via the upskilling modelling client 122 relating to the content experienced by the populations on the smart devices 120, including content type, interactions with the content (clicking, scrolling, reviewing, navigating, etc.), social media activity, messaging, network activity, etc. Lastly, the upskill manager 134 collects self-reported data from the population of users indicating a learning style of the user, e.g., visual, auditory, kinetic, combination thereof, etc.

The upskill manager 134 may extract one or more population features from the collected population data (step 204). In embodiments, the upskill manager 134 may extract the features from raw data streams, including the user audio, user video, user movement, user biometric data, etc., as well as the content, type, interaction therewith, etc., and may do so using techniques such as feature extraction, natural language processing, pattern/template matching, bag-of-words, term frequency—inverse document frequency (TF-IDF), optical character recognition, data analysis, etc. The extracted features may relate to a user interactivity level, for example the use of visual tools such as notetaking, highlighting, mapping, charting, outlining, etc. The features may also relate to a user outgoingness/quietness, for example participation in discussions, active listening, explaining, expression of opinions, providing comments/feedback, group study vs. solo study, and keen auditory memories (e.g., use of tones, rhythms, songs, jingles, etc.). In addition, the features may also relate to a level of user hands on activity, for example use of physical objects, role-playing/dancing/performing, etc. In embodiments, the features may further relate to user personality, for example interests of the user, resources used in research, user preferences, user natural language, user sentiment, user concentration level, circadian rhythms, etc. Lastly, the features may relate to the content experienced by the user, for example content type (e.g., audio, video, image, text, outlines, charts, flowcharts, tree diagrams, quizzes, flashcards, etc.), content topic, interactions with the content (e.g., scrolling, clicking, navigating, selecting, entering text, posting, reviewing, etc.), and the like. Overall, the upskill manager 134 may extract any feature from the raw data relevant to the interaction of the user population with the content.

Furthering the illustrative example introduced above, the upskill manager 134 extracts features from the population data for each of the users. From the collected video feed data streams, the upskill manager 134 extracts the reading of hardcopy books, the use of highlighters, notetaking, mouthing of words, etc. Similarly, and from the collected audio feed data streams, the upskill manager 134 may extract discussions with study partners, listening of lectures, use of songs/rhymes, user utterances and recitations, etc. In addition, and from the collected movement data streams, the upskill manager 134 may extract physical movement, such as the tapping of a foot or rehearsal of a performance. Lastly, and from the upskill managing client 122, the upskill manager 134 may extract one or more types of the content, interactions with the content (e.g., scrolling selecting, navigating, etc.), text, images, video, audio, social media activity, browsing history, etc.

The upskill manager 134 may train a learning style model (step 206). In exemplary embodiments, the upskill manager 134 trains the upskill models 132 which correlate one or more learning styles with one or more of the extracted features. In exemplary embodiments, the upskill manager 134 trains the upskill models 132 via supervised learning wherein users within the population identify a preferred learning style via self-reporting (e.g., a questionnaire) and the upskill manager 134 associates the labelled learning styles with the features extracted for those particular users in order to establish a learning type ground truth. Based on correlating the known types of learners with features extracted for those population users, the upskill manager 134 may generate the upskill models 132, from which an input of features for a user may output a most likely learning style of that user. While in the example embodiment the upskill manager 134 may implement supervised learning, in other embodiments the upskill manager 134 may implement semi-supervised or unsupervised learning via other techniques. In the example embodiment, the upskill manager 134 may train the upskill models 132 via machine learning techniques such as neural networks and regression. Moreover, the upskill models 132 may be further trained and tweaked over time through use of a feedback loop.

Furthering the illustrative example introduced above, the upskill manager 134 trains the upskill models 132 to correlate visual learners with features relevant to reading/writing, books, charts, videos, and following written directions. In addition, the upskill manager 134 trains the upskill models 132 to correlate auditory learners with features relevant to following verbal instructions, lectures, group work/discussion, and memory by listening (e.g., music). Finally, the upskill manager 134 trains the upskill models 132 to correlate kinetic learners with features relevant to demonstrations/hand's on approaches/field work, performances, and moving/taping/swinging a body part during thought.

The upskill manager 134 may collect user data (step 208). In exemplary embodiments, the upskill manager 134 may first receive information of a user based on, for example, login credentials, internet protocol (IP) address, media access control (MAC) address, etc., via the upskill managing client 122 and the network 108. The user information may include demographic information, such as user name, gender, date of birth, location, etc., as well as occupational, hobby, health, and device related data. The occupational data may include profession, education, expertise/field/domain, skills/proficiencies, deficiencies, sought positions/aspirations, etc., while the hobby data may include interests and hobbies of the individual. The health related data may be received via user/physician input, reference to an electronic health/medical record, etc., and may include one or more user health conditions relevant to learning impairments such as blindness, deafness, hard of hearing, mental incapacity, etc. In addition, the upskill manager 134 may further receive an environment configuration in which the upskilling modelling system 100 is implemented, such as mapping and pairing the sensors 110, positioning and calibrating the sensors 110, etc. In exemplary embodiments, the upskill manager 134 may collect individual data in much the same way the upskill manager 134 collects population data via reference to the sensors 110 and the upskill managing client 122. Here, however, the data is collected for a particular user, and in this case the user is not required to indicate a preferred learning style as in collecting the population data, above.

Returning to the earlier-introduced example, the up skill manager 134 receives user information that indicates the user is a 28-year-old accountant with no impairments. The upskill manager 134 collects video and audio data of the individual via a camera of the smart device 120 as well as movement data via reference to a smart watch. In addition, the upskill manager 134 collects content data such as content type experienced and content interactions via the upskill managing client 122.

The upskill manager 134 may extract one or more user features from the collected user data (step 210). In exemplary embodiments, the upskill manager 134 may extract user features from the collected user data in much the same way the upskill manager 134 extracts population features from the collected population data. Here, however, the features only relate to the user.

With reference again to the formerly introduced example, the upskill manager 134 extracts from the audio feed that the user recites information to themselves frequently and often participates in group discussion. In addition, the upskill manager 134 extracts via the upskill managing client 122 that the user frequently listens to audio lectures and podcasts.

The upskill manager 134 may identify one or more learning styles of the user (step 212). In embodiments, the upskill manager 134 may identify a learning style of the user based on inputting the extracted user features into the upskill models 132. In particular, the upskill manager 134 may compute a score for the user indicative of learning type based on the presence or absence of extracted user features. In addition, the upskill models 132 may further weight the features such that features more relevant to a particular learning style are weighted more/less than others. The upskill manager 134 may then determine a preferred learning style of the user based on, for example, a range in which the output score falls. Such learning styles may include aural, visual, kinetic, solitary, social, logical, etc., and the identified learning style may be a combination of one or more styles, for example 60% visual and 40% aural.

With reference again to the formerly introduced example, the upskill manager 134 identifies a learning style of the individual as aural based on the value computed by inputting the extracted user features into the upskill models 132.

The upskill manager 134 may suggest a most effective learning style to the user (step 210). In exemplary embodiments, the upskill manager 134 may suggest to the user the determined learning style and, in embodiments, materials for learning a topic of interest within that style. In embodiments, the learning style may include, for example, auditory, visual, or combinations thereof and the suggested materials within the topic of interest may include text, videos, images, audio, flowcharts, tree diagrams, hard/soft copies, lectures, note taking, outlining, using flash cards, quizzes, word associations, acronyms, etc. In embodiments, the upskill manager 134 may identify the topic of interest based on information received from the individual, such as employment, education, proficiencies, deficiencies, etc., and the materials may relate to, for example, education/training relevant to a profession, hobby, exercise, etc. The upskill manager 134 may identify such materials based on, for example, identifying required proficiencies for sought after or advanced positions of the individual, the proficiencies of comparable or more developed colleagues, aspirational positions or proficiencies, etc. For example, the upskill manager 134 may recommend to the user materials for training or a certification required for a promotion. In embodiments, the upskill manager 134 may be configured to identify materials for the user based on parsing opportunities relevant to the user, for example job postings similar to their current position, and identify suggested materials based on the required proficiencies that the user lacks. Alternatively, the upskill manager 134 may receive user input indicative of a learning style and/or types of materials that the user prefers, from which the upskill manager 134 may identify materials. Having identified a topic of the suggested materials, the upskill manager 134 may then provide materials related to that topic within the dominant learning style of the user.

Continuing the earlier introduced example, the upskill manager 134 determines that the accountant learns best aurally and that positions sought by the user often require that the user be a certified public accountant. Accordingly, the upskill manager 134 suggests audio lectures of courses required for a CPA to the user.

The upskill manager 134 may receive feedback (step 212). In exemplary embodiments, the upskill manager 134 may receive feedback in order to adjust the upskill models 132. In particular, the upskill manager 134 may receive feedback indicating whether the correct learning style and/or materials were identified, and the feedback may be received via, for example, continued monitoring, user input, follow-up evaluation (e.g., self-reporting, questionnaire, quiz), etc. Based on the received feedback, the upskill manager 134 may then adjust the upskill models 132, for example, by adjusting weights associated with features, in order to more accurately identify learning styles and materials for individuals within future iterations.

Concluding the previously introduced example, the upskill manager 134 may determine that the user does not finish most of the suggested audio lectures and instead suggest shorter lectures with frequent interaction.

FIG. 3 depicts a block diagram of devices used within the upskill managing system 100 of FIG. 1, in accordance with the exemplary embodiments. It should be appreciated that FIG. 3 provides only an illustration of one implementation and does not imply any limitations with regard to the environments in which different embodiments may be implemented. Many modifications to the depicted environment may be made.

Devices used herein may include one or more processors 02, one or more computer-readable RAMs 04, one or more computer-readable ROMs 06, one or more computer readable storage media 08, device drivers 12, read/write drive or interface 14, network adapter or interface 16, all interconnected over a communications fabric 18. Communications fabric 18 may be implemented with any architecture designed for passing data and/or control information between processors (such as microprocessors, communications and network processors, etc.), system memory, peripheral devices, and any other hardware components within a system.

One or more operating systems 10, and one or more application programs 11 are stored on one or more of the computer readable storage media 08 for execution by one or more of the processors 02 via one or more of the respective RAMs 04 (which typically include cache memory). In the illustrated embodiment, each of the computer readable storage media 08 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Devices used herein may also include a R/W drive or interface 14 to read from and write to one or more portable computer readable storage media 26. Application programs 11 on said devices may be stored on one or more of the portable computer readable storage media 26, read via the respective R/W drive or interface 14 and loaded into the respective computer readable storage media 08.

Devices used herein may also include a network adapter or interface 16, such as a TCP/IP adapter card or wireless communication adapter (such as a 4G wireless communication adapter using OFDMA technology). Application programs 11 on said computing devices may be downloaded to the computing device from an external computer or external storage device via a network (for example, the Internet, a local area network or other wide area network or wireless network) and network adapter or interface 16. From the network adapter or interface 16, the programs may be loaded onto computer readable storage media 08. The network may comprise copper wires, optical fibers, wireless transmission, routers, firewalls, switches, gateway computers and/or edge servers.

Devices used herein may also include a display screen 20, a keyboard or keypad 22, and a computer mouse or touchpad 24. Device drivers 12 interface to display screen 20 for imaging, to keyboard or keypad 22, to computer mouse or touchpad 24, and/or to display screen 20 for pressure sensing of alphanumeric character entry and user selections. The device drivers 12, R/W drive or interface 14 and network adapter or interface 16 may comprise hardware and software (stored on computer readable storage media 08 and/or ROM 06).

The programs described herein are identified based upon the application for which they are implemented in a specific one of the exemplary embodiments. However, it should be appreciated that any particular program nomenclature herein is used merely for convenience, and thus the exemplary embodiments should not be limited to use solely in any specific application identified and/or implied by such nomenclature.

Based on the foregoing, a computer system, method, and computer program product have been disclosed. However, numerous modifications and substitutions can be made without deviating from the scope of the exemplary embodiments. Therefore, the exemplary embodiments have been disclosed by way of example and not limitation.

It is to be understood that although this disclosure includes a detailed description on cloud computing, implementation of the teachings recited herein are not limited to a cloud computing environment. Rather, the exemplary embodiments are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 40 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and the exemplary embodiments are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and upskill processing 96. Upskill processing may relate to identifying a learning style of a user and providing relevant materials to the user within that learning style.

The exemplary embodiments may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for upskill management, the method comprising:
collecting data relating to a user experiencing content;
extracting one or more features from the data;
applying a model to the one or more features; and
identifying a learning style of the user based on the applied model.

2. The method of claim 1, further comprising:
identifying a topic of interest to the user; and
providing the user materials related to the topic of interest and in accordance with the identifying learning style.

3. The method of claim 2, wherein identifying a topic of interest to the user further comprises:
identifying one or more proficiencies required by one or more user opportunities;
identifying one or more proficiencies of the user; and
comparing the one or more proficiencies of the user to the one or more proficiencies required by the one or more opportunities.

4. The method of claim 1, wherein the model correlates a learning style with the one or more features.

5. The method of claim 4, wherein the model is trained via supervised machine learning.

6. The method of claim 1, wherein the one or more learning styles include a learning style selected from a group comprising visual, aural, kinetic, social, solitary, and logical.
one or more features include

7. The method of claim 1, wherein the data is selected from a group comprising audio, video, movement, biometric, and network;
and wherein the features are selected from a group comprising user interactivity level, user outgoingness/quietness, a level of user hands on activity, user personality, content type, and content interaction.

8. A computer program product for upskill management, the computer program product comprising:
one or more non-transitory computer-readable storage media and program instructions stored on the one or more non-transitory computer-readable storage media capable of performing a method, the method comprising:
collecting data relating to a user experiencing content;
extracting one or more features from the data;
applying a model to the one or more features; and
identifying a learning style of the user based on the applied model.

9. The computer program product of claim 8, further comprising:
identifying a topic of interest to the user; and
providing the user materials related to the topic of interest and in accordance with the identifying learning style.

10. The computer program product of claim 9, wherein identifying a topic of interest to the user further comprises:
identifying one or more proficiencies required by one or more user opportunities;
identifying one or more proficiencies of the user; and
comparing the one or more proficiencies of the user to the one or more proficiencies required by the one or more opportunities.

11. The computer program product of claim 8, wherein the model correlates a learning style with the one or more features.

12. The computer program product of claim 12, wherein the model is trained via supervised machine learning.

13. The computer program product of claim 8, wherein the one or more learning styles include a learning style selected from a group comprising visual, aural, kinetic, social, solitary, and logical.
one or more features include

14. The computer program product of claim 8, wherein the data is selected from a group comprising audio, video, movement, biometric, and network;
and wherein the features are selected from a group comprising user interactivity level, user outgoingness/quietness, a level of user hands on activity, user personality, content type, and content interaction.

15. A computer system for upskill management, the system comprising:
one or more computer processors, one or more computer-readable storage media, and program instructions stored on the one or more of the computer-readable storage media for execution by at least one of the one or more processors capable of performing a method, the method comprising:
collecting data relating to a user experiencing content;
extracting one or more features from the data;
applying a model to the one or more features; and
identifying a learning style of the user based on the applied model.

16. The computer system of claim 15, further comprising:
identifying a topic of interest to the user; and
providing the user materials related to the topic of interest and in accordance with the identifying learning style.

17. The computer system of claim 16, wherein identifying a topic of interest to the user further comprises:
identifying one or more proficiencies required by one or more user opportunities;
identifying one or more proficiencies of the user; and
comparing the one or more proficiencies of the user to the one or more proficiencies required by the one or more opportunities.

18. The computer system of claim 15, wherein the model correlates a learning style with the one or more features.

19. The computer system of claim 18, wherein the model is trained via supervised machine learning.

20. The computer system of claim 15, wherein the one or more learning styles include a learning style selected from a group comprising visual, aural, kinetic, social, solitary, and logical.
